(19) United States
(12) Patent Application Publication
(10) Pub. No.: US 2025/0240781 A1
(43) Pub. Date: Jul. 24, 2025

(54) METHODS, COMMUNICATIONS DEVICES, AND INFRASTRUCTURE EQUIPMENT

(71) Applicant: Sony Group Corporation, Tokyo (JP)

(72) Inventors: Yassin Aden AWAD, Basingstoke (GB); Samuel Asangbeng ATUNGSIRI, Basingstoke (GB); Vivek SHARMA, Basingstoke (GB); Hideji WAKABAYASHI, Basingstoke (GB)

(73) Assignee: Sony Group Corporation, Tokyo (JP)

(21) Appl. No.: 18/699,353

(22) PCT Filed: Sep. 9, 2022
(86) PCT No.: PCT/EP2022/075108

§ 371 Date: Apr. 8, 2024

(30) Foreign Application Priority Data
Oct. 21, 2021 (EP) 21204071.1

(51) Int. Cl. H04W 72/1268; H04B 17/318; H04W 74/0833

(52) U.S. Cl. CPC H04W 72/1268; H04B 17/328; H04W 74/0833

(57) ABSTRACT

A method comprising determining that a communications device has uplink data to transmit to a wireless communications network, determining, independently from the wireless communications network, periodically occurring uplink resources of the wireless radio interface in which the uplink data is to be transmitted, wherein the uplink resources comprise a control resource and a data resource, both of the control resource and the data resource being associated with the communications device, determining, independently from the wireless communications network, values of a plurality of scheduling parameters with which the uplink data is to be transmitted, transmitting, to the wireless communications network within the control resource, scheduling information indicating that the communications device is to transmit the uplink data to the wireless communications network in accordance with the determined values of the plurality of scheduling parameters.

### BACKGROUND

### Field of Disclosure

The present disclosure relates to communications devices, infrastructure equipment and methods for the more efficient operation of a communications device in a wireless communications network.

The present application claims the Paris Convention priority from European patent application number EP21204071.1, filed 21 Oct. 2021, the contents of which are hereby incorporated by reference.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Previous generation mobile telecommunication systems, such as those based on the 3GPP defined UMTS and Long Term Evolution (LTE) architecture, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Current and future wireless communications networks are expected to routinely and efficiently support communications with an ever-increasing range of devices associated with a wider range of data traffic profiles and types than existing systems are optimised to support. For example, it is expected future wireless communications networks will be expected to efficiently support communications with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example, different consideration may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is expected to be a desire for current future wireless communications networks, for example those which may be referred to as 5G or new radio (NR) systems/new radio access technology (RAT) systems or indeed future 6G wireless communications, as well as future iterations/releases of existing systems, to efficiently support connectivity for a wide range of devices associated with different applications and different characteristic data traffic profiles and requirements.

One example of a new service is referred to as Ultra Reliable Low Latency Communications (URLLC) services which, as its name suggests, requires that a data unit or packet be communicated with a high reliability and with a low communications delay. URLLC type services therefore represent a challenging example for both LTE type communications systems and 5G/NR communications systems, as well as future generation communications systems.

The increasing use of different types of network infrastructure equipment and terminal devices associated with different traffic profiles give rise to new challenges for efficiently handling communications in wireless communications systems that need to be addressed.

### SUMMARY OF THE DISCLOSURE

The present disclosure can help address or mitigate at least some of the issues discussed above.

Embodiments of the present technique can provide a method of operating a communications device configured to transmit signals to and/or to receive signals from a wireless communications network via a wireless radio interface provided by the wireless communications network. The method comprises determining that the communications device has uplink data to transmit to the wireless communications network, determining, independently from the wireless communications network, periodically occurring uplink resources of the wireless radio interface in which the uplink data is to be transmitted, wherein the uplink resources comprise a control resource and a data resource, both of the control resource and the data resource being associated with the communications device, determining, independently from the wireless communications network, values of a plurality of scheduling parameters with which the uplink data is to be transmitted, transmitting, to the wireless communications network within the control resource, scheduling information indicating that the communications device is to transmit the uplink data to the wireless communications network in accordance with the determined values of the plurality of scheduling parameters, and transmitting, to the wireless communications network within the data resource, the uplink data in accordance with the determined values of the plurality of scheduling parameters.

Embodiments of the present technique, which, in addition to methods of operating communications devices, relate to methods of operating infrastructure equipment, communications devices and infrastructure equipment, circuitry for communications devices and infrastructure equipment, wireless communications systems, computer programs, and computer-readable storage mediums, can allow for more efficient use of radio resources by a communications device operating in a wireless communications network.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device which may be configured to operate in accordance with certain embodiments of the present disclosure;

FIG. 4 illustrates how different UEs can be assigned separate spatial-layer resources;

FIG. 5 illustrates how different UEs can be assigned separate frequency-domain resources;

FIG. 6 illustrates how different UEs can be assigned separate time-domain resources;

FIG. 7 shows a part schematic, part message flow diagram representation of a wireless communications system comprising a communications device and an infrastructure equipment in accordance with embodiments of the present technique;

FIG. 8 shows a first example of separate control and data resources within pre-assigned dedicated resources for a UE in accordance with embodiments of the present technique;

FIG. 9 shows a second example of separate control and data resources within pre-assigned dedicated resources for a UE, where the control resource is divided into five portions, in accordance with embodiments of the present technique;

FIG. 10 shows a third example of separate control and data resources within pre-assigned dedicated resources for a UE, where the control resource may consist of only a first portion with remaining control resources being used as data resources, in accordance with embodiments of the present technique;

FIG. 11 shows an example of a control resource embedded with data resources within pre-assigned dedicated resources for a UE in accordance with embodiments of the present technique;

FIG. 12 shows a time-line defining the operation of a new timer used by a UE based on whether or not it has uplink data to transmit within pre-assigned dedicated resources in accordance with embodiments of the present technique; and

FIG. 13 shows a flow diagram illustrating a process of communications in a communications system in accordance with embodiments of the present technique.

### DETAILED DESCRIPTION OF THE EMBODIMENTS

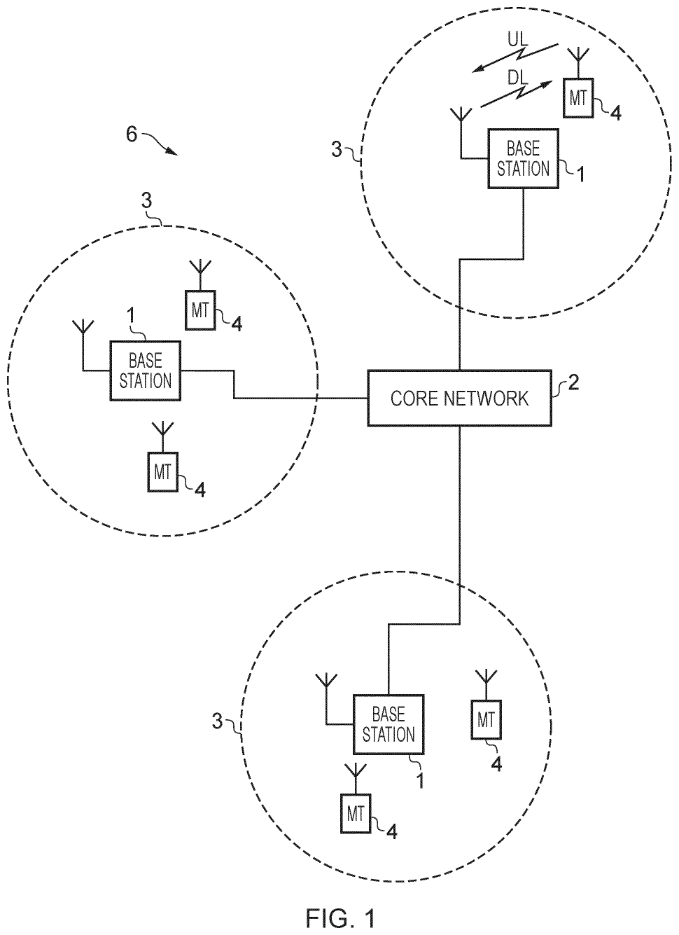

Long Term Evolution Advanced Radio Access Technology (4G) FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body, and also described in many books on the subject, for example, Holma H. and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices 4 within their respective coverage areas 3 via a radio downlink. Data is transmitted from communications devices 4 to the base stations 1 via a radio uplink. The core network 2 routes data to and from the communications devices 4 via the respective base stations 1 and provides functions such as authentication, mobility management, charging and so on. Terminal devices may also be referred to as mobile stations, user equipment (UE), user terminal, mobile radio, communications device, and so forth. Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

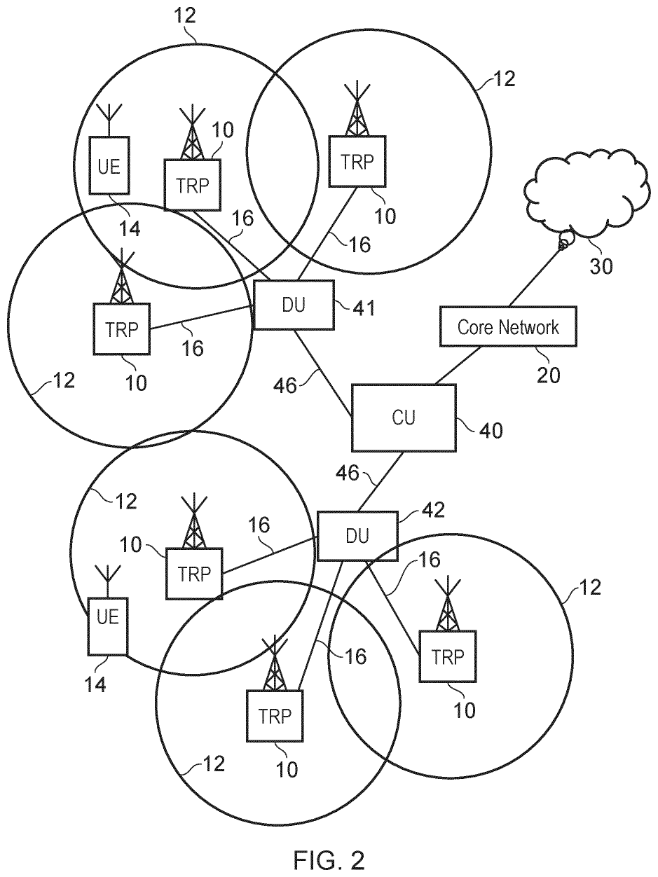

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 12 via one of the distributed units/TRPs 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus, certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a control unit/controlling node 40 and/or a TRP 10 of the kind shown in FIG. 2 which is adapted to provide functionality in accordance with the principles described herein.

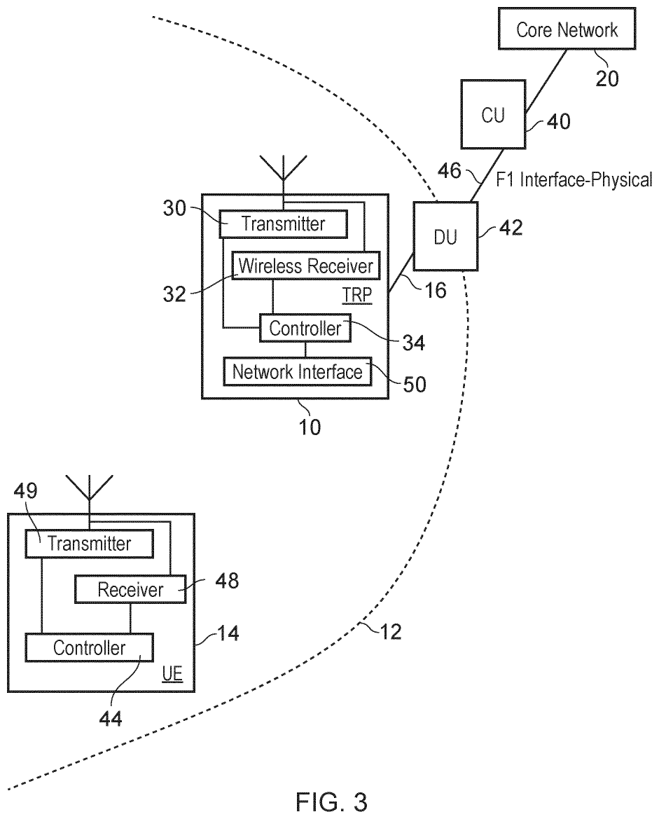

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, an example UE 14 is shown to include a corresponding transmitter 49, a receiver 48 and a controller 44 which is configured to control the transmitter 49 and the receiver 48 to transmit signals representing uplink data to the wireless communications network via the wireless access interface formed by the TRP 10 and to receive downlink data as signals transmitted by the transmitter 30 and received by the receiver 48 in accordance with the conventional operation.

The transmitters 30, 49 and the receivers 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controllers 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473, and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP10 to the DU 42 and the F1 interface 46 from the DU 42 to the CU 40.

URLLC and eURLLC

Systems incorporating NR technology are expected to support different services (or types of services), which may be characterised by different requirements for latency, data rate and/or reliability. For example, Enhanced Mobile Broadband (eMBB) services are characterised by high capacity with a requirement to support up to 20 Gb/s. The requirements for Ultra Reliable and Low Latency Communications (URLLC) services are for one transmission of a 32 byte packet to be transmitted from the radio protocol layer 2/3 SDU ingress point to the radio protocol layer 2/3 SDU egress point of the radio interface within 1 ms with a reliability of 1-10⁻⁵ (99.999%) or higher (99.9999%) [2].

Massive Machine Type Communications (mMTC) is another example of a service which may be supported by NR-based communications networks. In addition, systems may be expected to support further enhancements related to Industrial Internet of Things (IIoT) in order to support services with new requirements of high availability, high reliability, low latency, and in some cases, high-accuracy positioning.

Enhanced URLLC (eURLLC) [3] specifies features that require high reliability and low latency, such as factory automation, transport industry, electrical power distribution, etc. in a 5G system. eURLLC is further enhanced as IIoT-URLLC [4], for which one of the objectives is to enhance UE feedback for Hybrid Automatic Repeat Request Acknowledgements (HARQ-ACK) for Physical Downlink Shared Channel (PDSCH) transmissions.

### Future 6G Wireless Communications

As described above, several generations of mobile communications have been standardised globally up to now, where each generation took approximately a decade from introduction before the development and introduction of another new generation. For example, generations of mobile communications have moved from the Global System for Mobile Communications (GSM) (2G) to Wideband Code Division Multiple Access (WCDMA) (3G), from WCDMA (3G) to LTE (4G), and most recently from LTE (4G) to NR (5G).

The latest generation of mobile communications is 5G, as discussed above with reference to the example configurations of FIGS. 2 and 3, where a significant number of additional features have been incorporated in different releases to provide new services and capabilities. Such services include eMBB, IIoT and URLLC as discussed above, but also include such services as 2-step Random Access (RACH), Unlicensed NR (NR-U), Cross-link Interference (CLI) handling for Time Division Duplexing (TDD), Positioning, Small Data Transmissions (SDT), Multicast and Broadcast Services (MBS), Reduced Capability UEs, Vehicular Communications (V2X), Integrated Access and Backhaul (IAB), UE power saving, Non Terrestrial Networks (NTN), NR operation up to 71 GHz, IoT over NTN, Non-public networks (NPN), and Radio Access Network (RAN) slicing.

Nevertheless, as in every decade, a new generation (e.g. 6G) is expected to be developed and deployed in the near future (around the year 2030), and will be expected to provide new services and capabilities that the current 5G cannot provide.

One of the areas for investigation for future mobile communications networks is uplink (UL) scheduling enhancements, which are expected to be required due to the increased number of services that require low latency communications and high reliability, as well as high throughput UL data transmissions from the terminal, like tactile internet, Audio-Video field production, and extended Reality (XR). In essence, it is proposed that a mobile terminal should be able to schedule unrestricted UL resources immediately after data arrives in its buffer for transmission, while taking into account the link adaptation parameters so that the transmissions are mostly ensured to be successful.

A typical use case (e.g. for broadcast TV production) is a camera transmitting a video stream using the User Data Protocol (UDP)/Internet Protocol (IP) protocol stack. In layer 2 of this protocol stack (L2), Radio Link Control-Unacknowledged Mode (RLC-UM) mode will be configured for UDP. Accordingly, dedicated (and probably regular) resources may be configured by the network, using techniques like periodic UL grant or configured grant. Such techniques are already developed and available.

As an example scenario, there might be a video algorithm which requires a camera not to transmit any uplink video frames if the view does not change. But as soon as the view changes, video codecs will have data available for transmission in L2 buffers. If traditional techniques are relied upon, the camera/UE must request UL resources before transmitting on the uplink. This likely involves additional signalling and latency which is detrimental to live production.

Further aspects of UL scheduling may be found in co-pending European patent application published under number EP3837895 [5], the contents of which are hereby incorporated by reference.

### Link Adaptation in Existing Mobile Communications Networks

The lower layers (MAC and physical layers) of a mobile communication system are designed to create a radio waveform used for conveying data between a transmitter and receiver given some expected radio propagation conditions between the communicating gNB and the UE. In traditional link-layer designs, these layers are designed to allow the radio-communication system to cope with a given degree of radio propagation impairment. The success of mobile communication systems over the last few decades has been mainly due to the adoption of link adaptation that helps to maximise the throughput. In mobile communication systems such as 3G, 4G and 5G, the link-layer is designed with many choices for the forward error correction (FEC) code rates, modulation constellations, waveform type, transmit power levels. These can be jointly selected into sets of transmission parameters. Each set can be thought of as a parametrisation for the generation of the transmitted signal resulting from the joint choices that make the set. A given set is expected to generate a waveform or signal for transmission that is different from what another set would generate. Therefore, a deliberate choice can be made of a particular set of transmission parameters with the expectation that it would generate a transmission signal that is somehow more suitable for a prevailing set of radio channel propagation conditions than another set.

This method of designing link-layers is rather long-winded and laborious because it is difficult to deliberately determine the set of choices for all the configuration parameters. This is firstly, and especially, because the process of choosing between particular communication signal processing techniques such as FEC coding schemes (Low Density Parity Check (LDPC) codes, Turbo codes, or Polar codes, for example) is not trivial. Secondly, this is because even after a particular communication signal processing technique has been chosen, deciding on the set of possible configurations of the chosen technique that have to be designed and standardised is also an onerous process. As an example, if we consider only the FEC, then the radio communication system designer may have to first choose the FEC scheme (LDPC, Turbo or Polar codes etc.), then having chosen the FEC scheme, would need to then decide what block sizes and code rates to support etc. before proceeding to a similar process for modulation constellations etc.

Assuming that the radio-communication system has been designed already, such a system design has already chosen a coding scheme. In addition, it supports a designed number of possible codeword block sizes, a designed number of code rates per block size, a designed number of modulation constellations etc. Link adaptation allows the UE and gNB to work together to determine automatically:
1. the prevailing radio propagation conditions that will affect the transmitted data; and
2. the most appropriate set of link-layer configuration parameters (block size, code rate, modulation constellation etc.) to use so as to maximise throughput and/or transmission resource utilisation for the transmitted data within target reliability and/or latency under the prevailing radio propagation conditions.

This choice of an appropriate set of link-layer configuration parameters is also not trivial as it presents a somewhat multi-dimensional problem with the decision depending for example on the given transmission block size and the prevailing radio propagation channel conditions etc. Link adaptation in 4G and 5G systems is limited to the selection of a configuration from amongst a set of designed choices. For link adaptation of the downlink (DL), the UE measures channel quality parameters on the reception of reference signals transmitted by the BS. The channel quality is then signalled to the BS as a channel quality indicator (CQI) that can be either narrowband or wideband depending on the bandwidth of the reference signals used for its measurement. Based on this CQI report from the UE, the BS can adapt its DL transmissions to maximise throughput. Similarly, for the UL the BS measures channel quality parameters from reception of sounding reference signals (SRS) transmitted by the UE and uses the results of these measurements to instruct the UE how to adapt UL transmissions to maximise throughput. In 4G and 5G systems, since the FEC type for data channels is fixed, link adaptation therefore only involves the selection from a set of possible FEC code rates and modulation constellations—i.e. the modulation and coding scheme (MCS). Transmit power can also be thought of as an aspect of link adaptation, but is not typically adjusted per transmission block.

### Legacy Scheduling Methods in NR (5G)

In cellular wireless communications, the channel between a mobile terminal and the base-station experiences typically rapid and significant variations which impacts the quality of the received signal. In the small-scale variation, the channel goes through frequency selective fading which results in rapid and random variations in the channel attenuation. In the large-scale variation, there are shadowing and distance related pathloss which affect the average received signal strength. In addition, there is interference arising from transmissions from nearby cells and terminals which distorts the signal at the receiver side.

In practice, the heart of mitigating and exploiting the variations of the channel condition is the scheduling mechanism that implements link adaptation algorithms, such as adaptive modulation and coding schemes (AMCS), dynamic power control and channel-dependent scheduling.

In NR, the downlink and uplink multi-user schedulers are located at the base-station (gNB) where, in principle, the scheduler assigns the resources for the users with the best channel conditions in a given instance in both the UL and DL while taking into account the fairness among users as well. There are two types of scheduling mechanism, and these are termed as dynamic scheduling (or dynamic grant) and semi-persistent scheduling (or configured grant).

In dynamic multi-user scheduling for downlink transmissions, based on the instantaneous channel condition where the terminal feeds back the channel quality indicator (CQI) derived from downlink reference signals (RS) at regular time-intervals to the gNB, the scheduler at the gNB, after receiving the CQI, decides the best modulation and coding scheme (MCS), best “available” frequency resources (physical resource blocks (PRBs)) and adequate power for the downlink data transmissions for some users at a given subframe/slot. The downlink scheduling decisions, which are known as scheduling assignments, are carried by downlink control information (DCI), which is transmitted in the downlink to the scheduled users.

Similarly, for the dynamic multi-user scheduling for uplink transmission, based on the instantaneous channel condition where the terminal sends channel SRS at regular time-intervals to the gNB, the scheduler at the gNB, after deriving the CQI based on the last received SRS, decides the best modulation and coding scheme, best frequency resources (PRBs) for the uplink data transmissions from some users at a given subframe/slot. The uplink scheduling decisions, which are also known as scheduling assignments, are carried by downlink control information (DCI) which is transmitted in the downlink to the scheduled users.

For semi-persistent scheduling (SPS) however, the resources are pre-configured semi-statically (e.g. via radio resource control (RRC) signalling) with a certain periodicity, where this periodicity is aligned with the data arrival rate for a particular service. There is an SPS for the downlink (known as DL SPS) and an SPS for the uplink, which is referred to as configured grant (CG).

CG resources are mainly intended to deliver multiple traffic classes in a timely manner from the terminal, where such traffic classes have small data rates and some kind of periodicity, as specified in URLLC/IIoT in NR Rel-16/17. Some examples of the different traffic classes include industrial automation (future factory), energy power distribution, and intelligent transport systems, voice.

Issues with Legacy Scheduling Methods

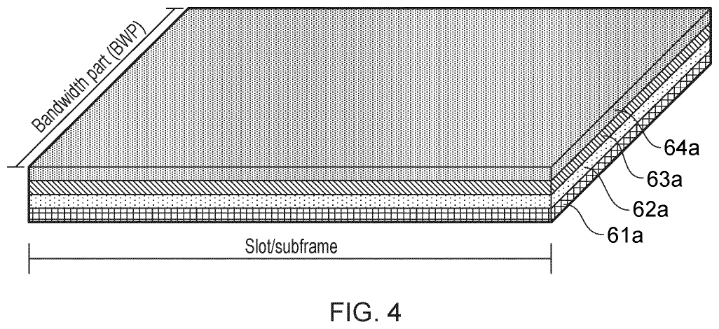

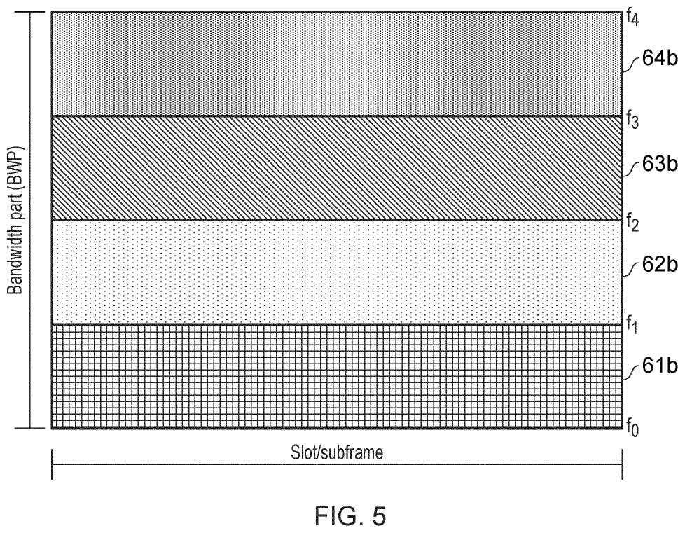

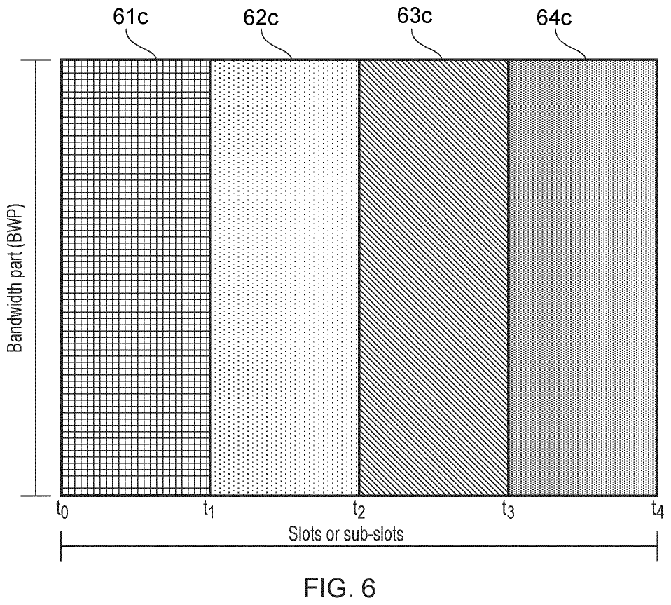

As described above, CG resources are mainly intended for traffic with a low data rate and with some kind of periodicity, as specified in URLLC/IIoT in NR Rel-16/17. However, for traffic with a high data rate and which requires low latency, larger resources would be needed. In this case, a UE can be pre-configured with dedicated larger resources for such uplink data transmissions. These resources can be allocated by one of the following methods (or by a combination of these methods):
Spatial-domain allocation: In this method, the gNB pre-allocates a specific spatial layer to the UE, where different UEs are allocated to different spatial layers in a bandwidth part (BWP), similar to multi-user multiple-input and multiple-output (MU-MIMO). This means that a UE has pre-allocated resources in the spatial-domain for both control and data. Hence, when the UE has data to transmit, the UE uses resources in the spatial layer reserved for it. The spatial-domain resource can be configured for a full set or a sub-set of BWP resources. As shown in the example in FIG. 4, a first UE may be assigned a first spatial layer 61a, a second UE may be assigned a second spatial layer 62a, a third UE may be assigned a third spatial layer 63a, and a fourth UE may be assigned a fourth spatial layer 64a;
Frequency-domain allocation: Similarly, to spatial-domain resources, dedicated frequency-domain resources can be pre-assigned to the UE where different UEs are allocated different frequency resources in a system bandwidth or a BWP. Hence, when data arrives at the UE's buffer, the UE uses the frequency resources allocated for it. As shown in the example in FIG. 5, a first UE may be assigned a first frequency resource set 61b (i.e. frequency range f₀-f₁), a second UE may assigned a second frequency resource set 62b (i.e. frequency range f₁-f₂), a third UE may assigned a third frequency resource set 63b (i.e. frequency range f₂-f₃), and a fourth UE may assigned a fourth frequency resource set 64b (i.e. frequency range f₃-f₄); and
Time-domain allocation: Similarly, to both spatial and frequency-domain resources, dedicated time-domain resources can be pre-allocated for a UE where different UEs are allocated different time resources (e.g. different sub-slots or slots) in a component carrier or BWP. As shown in the example in FIG. 6, a first UE may be assigned a first time resource set 61c (i.e. time range t₀-t₁), a second UE2 may be assigned a second time resource set 62c (i.e. time range t₁-t₂), a third UE may be assigned a third time resource set 63c (i.e. time range t₂-t₃), and a fourth UE may be assigned a fourth time resource set 64c (i.e. time range t₃-t₄).

An issue with using pre-configured dedicated resources for uplink data transmissions is that the resources are always reserved in advance, regardless of whether a UE actually has data to transmit or not. Even though a UE is able to release these pre-configured resources after finishing its UL data transmissions, the concern is that the signalling and commands for re-allocating/re-activating the resources will come from the network, which may result in some unbearable delays for a variety of services like Heavy uplink URLLC, and will also involve signaling from the UE to request resources either via a scheduling request (SR), or initiating a RACH procedure, or will involve resources being configured for idle periods.

Another issue with pre-configured resources is that a UE may not be able to control completely the link adaptation parameters, such as frequency-domain scheduling, in order to choose the best frequency resources (PRBs) in a BWP, modulation and coding scheme (MCS), etc. Since the UE has to wait, after sending its measurements and/or SRS to the network, for the network to determine such link adaptation parameters and signal these to the UE, which both introduces latency and means that the most appropriate parameters may not be selected as the channel conditions may have changed between the time that the UE performed the measurements and/or transmitted the SRS and the time that the UE receives the link adaptation parameters from the gNB.

Another issue with pre-configured resources is that a UE may have to use all the resources whenever it has data to transmit, because the gNB and UE must be synchronised for the allocated resources. This may mean that a UE must add padding bits in order to fill the remaining resources. This is clearly not desirable, as it increases the UE's power consumption unnecessarily, and also generates interference for other UEs located in the same cell or in neighboring cells.

Accordingly, some enhancements for UL scheduling will be required for future mobile communications networks, such as 5G-Advanced and 6G. A set of requirements for such enhanced UL scheduling can be envisioned as listed below:
Immediate transmission of the UL data in order to reduce latency, for example for applications requiring heavy UL data with low latency;
Choosing appropriate link adaptation parameters, for example the best frequency resources (PRBs), MCS, power, etc.;
Flexible resource allocation scheme, for example frequency domain resource allocation (FDRA) and/or time domain resource allocation (TDRA);
An efficient way of identifying a UE and its resource allocation dynamically at the gNB receiver; and
Improving spectral efficiency of the cell, so that when a UE is not using its allocated resources, another UE could in principle be assigned such resources.

Embodiments of the present disclosure seek to provide solutions to such issues as mentioned above, whilst seeking to meet the requirements for enhanced UL scheduling as described above.

### UE-Based Scheduling and Link Adaptation Methods for UL Data Transmission

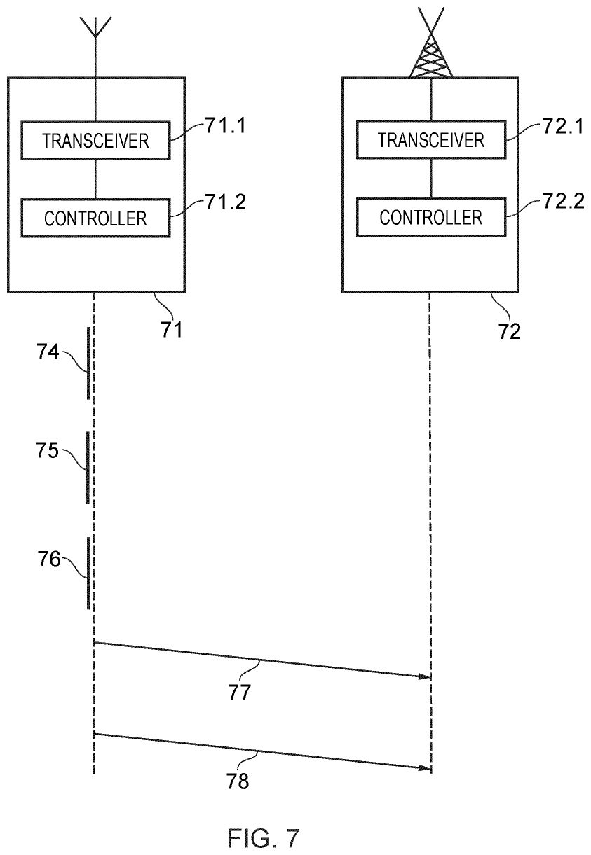

FIG. 7 shows a part schematic, part message flow diagram representation of a first wireless communications system comprising a communications device 71 and an infrastructure equipment 72 in accordance with at least some embodiments of the present technique. The communications device 71 is configured to transmit signals to and/or receive signals from the wireless communications network, for example, to and from the infrastructure equipment 72. Specifically, the communications device 71 may be configured to transmit data to and/or receive data from the wireless communications network (e.g. to/from the infrastructure equipment 72) via a wireless radio interface provided by the wireless communications network (e.g. the Uu interface between the communications device 71 and the Radio Access Network (RAN), which includes the infrastructure equipment 72), while the communications device is operating in a connected mode (e.g. RRC_CONNECTED) with the wireless communications network. The communications device 71 and the infrastructure equipment 72 each comprise a transceiver (or transceiver circuitry) 71.1, 72.1, and a controller (or controller circuitry) 71.2, 72.2. Each of the controllers 71.2, 72.2 may be, for example, a microprocessor, a CPU, or a dedicated chipset, etc.

As shown in the example of FIG. 7, the transceiver circuitry 71.1 and the controller circuitry 71.2 of the communications device 71 are configured in combination to determine 74 that the communications device 71 has uplink data to transmit to the wireless communications network (e.g. to the infrastructure equipment 72), to determine 75, independently from the wireless communications network, periodically occurring uplink resources (e.g. grant free resources such as configured grant (CG) resources) of the wireless radio interface in which the uplink data is to be transmitted, wherein the uplink resources comprise a control resource and a data resource, both of the control resource and the data resource being associated with the communications device 71, to determine 76, independently from the wireless communications network, values of a plurality of scheduling parameters with which the uplink data is to be transmitted, to transmit 77, to the wireless communications network (e.g. to the infrastructure equipment 72) within the control resource, scheduling information (e.g. as uplink control information (UCI) within a PUCCH or PUSCH) indicating that the communications device 71 is to transmit the uplink data to the wireless communications network (e.g. to the infrastructure equipment 72) in accordance with the determined values of the plurality of scheduling parameters, and to transmit 78, to the wireless communications network (e.g. to the infrastructure equipment 72) within the data resource, the uplink data (e.g. within a PUSCH) in accordance with the determined values of the plurality of scheduling parameters.

Essentially, embodiments of the present technique propose that a UE is pre-assigned dedicated uplink resources for UL control and data transmissions, where these resources comprise UE-specific control resources and associated data resources. Embodiments of the present technique further propose that the UE takes control of own scheduling decisions (or assignments) for its UL data transmissions, where such assignments are confined within the dedicated resources. Embodiments of the present technique can be implemented via at least one or both of the following methods:
Dynamic scheduling via UE-specific control resource, where this UE-specific control resource is always available for scheduling the UL data—and cannot be re-allocated to any other UEs—and can be configured with periodicities based on traffic profile; or
Advance scheduling via control resources embedded/piggy-backed on data resources.

In currently known solutions, such as in Rel-16/17 NR, configured grant (CG) is supported where most of the scheduling parameters are configured in advance by the network. The basic principle of conventional scheduling is that firstly, a UE sends a report (e.g. buffer status (BSR) of the UE, transmission power headroom of the UE, etc.) to the network. The UE therefore provides assistance to the network for the purposes of scheduling, but it is the network itself which is the decision maker in terms of scheduling. Here, in conventional scheduling, the UE's discretion is very limited. A UE cannot schedule itself, for example its CG resource allocation is always fixed, except that the UE may include a few limited parameters in the CG-UCI embedded within the CG-PUSCH. However, the UE has a better knowledge of uplink scheduling information than the network, in terms of, for example, the arrival of data in the UE buffer, channel quality, transmission power and so on. Network-based scheduling decision making requires many reports to be received from the UE and for the transmission control signalling from the network to the UE in order to indicate the result of the network's decision making. As a result of this, the signalling overhead is large and decision making is delayed. On the contrary, embodiments of the present disclosure allow for a UE to have pre-configured resources for both control and data, where the UE is able to schedule itself for variable sizes of resource allocations and also independently determine the link adaptation parameters to use.

In at least some arrangements of embodiments of the present disclosure, the UE is in connected mode, and it may be the case—in order to ensure efficient operation of the network with respect to, for example, UE and network loads and the risk of collisions between UEs—that the number of UEs that require the configuration so as to operate in accordance with embodiments of the present disclosure is not particularly large (i.e. only heavy uplink UEs). However, embodiments of the present disclosure are not so limited, and the communications devices could for example operate in accordance with an inactive mode. Those skilled in the art would appreciate here that reference to resources herein may relate to resources in the spatial domain, frequency domain, or time domain (as illustrated in FIGS. 4 to 6) or any combination thereof, in a BWP or a full component carrier.

Dynamic scheduling from the UE can be designed in such a way that there is both control signalling (and optionally associated data) where a UEfirst transmits scheduling decisions in the control resource, and then this may be followed by scheduled data transmitted within the data resource, where all control signalling and uplink data is located within the pre-configured resources. The scheduled resources for the data can be smaller than the total amount of pre-configured data resources (i.e. only a portion of the data resource can be used for transmitting the uplink data) depending on the amount of available data to be transmitted at a given time.

A UE can be assigned dedicated “separate” control resources for transmitting the scheduling information for UL data (where this UL data may be transmitted in, for example, a Physical Uplink Shared Channel (PUSCH)). The location of each UE's control resource is pre-configured by the network, and it is known to both gNB and UE. Here, where the control resource is separate from the data resource, the data resource in which the uplink data is transmitted may be within the same uplink transmission occasion as the control resource in which the scheduling information is transmitted.

The control indication from the UE can be carried on a Physical Uplink Control Channel (PUCCH), which is placed on the dedicated control resource. In order to identify the UE, a cyclic redundancy check (CRC) masked with the UE ID is always included in the PUCCH channel (or indeed in a PUSCH along with uplink data transmitted in the data resource). In other words, the scheduling information comprises an identifier associated with the communications device. If the gNB does not detect this PUCCH, it will assume that the UE did not transmit any control information.

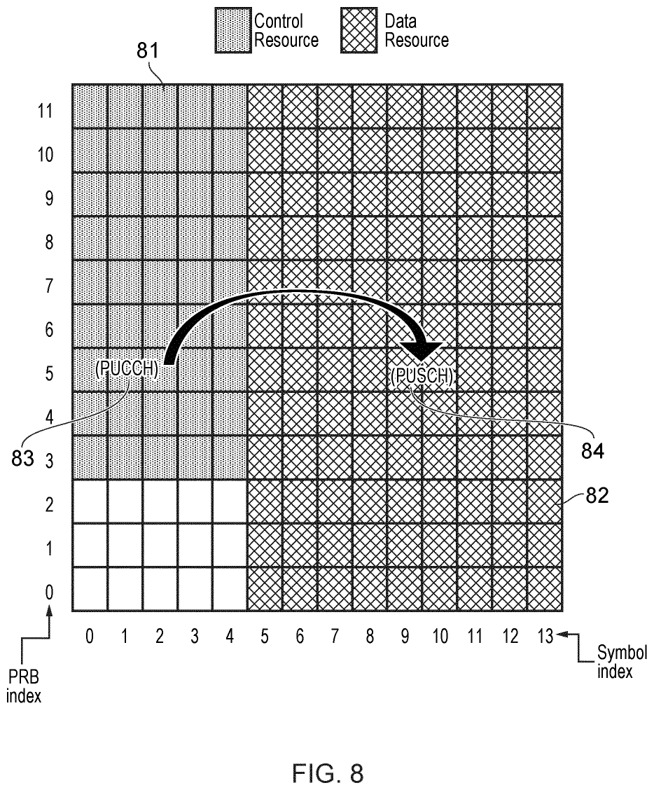

The PUCCH must be transmitted and placed before the data channel (PUSCH), so that the scheduling information and control signalling is decoded by the gNB before the PUSCH is received in order to reduce the latency of decoding and buffering of the data channel, as shown in FIG. 8, which shows a first example of separate control resources 81 and data resources 82 within pre-assigned dedicated resources for a UE in accordance with embodiments of the present technique. If the gNB decodes the PUCCH 83 received within the control resources 81, but not the PUSCH 84 received within the data resources 82, the gNB will send a negative acknowledgement (NACK) to the UE. Otherwise, the gNB will transmit a positive acknowledgement (ACK) to the UE.

In this design, where the control and data resources are separate as illustrated in the example of FIG. 8, the PUCCH carries the scheduling information from the UE, where such scheduling information may contain at least the following scheduling parameters:
Resource allocation: Frequency-domain resource blocks in terms of number of PRBs (starting and ending PRBs) and time-domain allocation in terms of number of orthogonal frequency division multiplexing (OFDM) symbols (starting and ending symbols);
Transport block-related (TBS): Modulation and coding scheme (MCS) i.e. a modulation scheme (QPSK, 16QAM, etc.) and a coding rate (ratio of amount of information bits to the total number of bits that are transmitted), new data indicator (NDI), and redundancy version (RV);
HARQ-related: HARQ process number (HPN);
Multiple-antenna-related: demodulating reference signals (DMRS), antenna ports, precoding information, SRS, etc.; and
Continuing or taking up again: UE informs the gNB that it will continue to schedule for subsequent data.

In other words, the plurality of scheduling parameters each relate to at least one of: information relating to a resource allocation for the uplink data; information relating to transport blocks to be used to carry the uplink data; information regarding a Hybrid Automatic Repeat Request, HARQ, protocol in accordance with which the uplink data is to be transmitted; and information regarding one or more antennas of the communications device via which the uplink data is to be transmitted.

One important parameter noted above is the “Continuing or taking up again” parameter, where the UE informs the gNB that it will continue to schedule itself for further data on the subsequent resources, so that the network is aware that the resource will be used again for the same UE. In other words, the plurality of scheduling parameters comprises a continuation indicator, the continuation indicator being included within the scheduling information and indicating whether or not the communications device is to transmit further data within resources of the next uplink transmission occasion to the uplink transmission occasion in which the uplink data is transmitted.

Such a parameter may work similarly to the buffer status report (BSR) or application layer session continuity indicator, like “on-air” for broadcast TV camera production. The value of the “Continuing or taking up again” parameter may be “True” or “False”—where “True” means that the UE will continue to use the resources and “False” means the resources (specifically the data resource, as the control resource is always reserved for the UE) are freed until there is further data available in the UE buffer.

Alternatively, the value of the “Continuing or taking up again” parameter may be a binary number where “1” means that the UE will continue to use the resources and “0” means the resources (specifically the data resource, as the control resource is always reserved for the UE) are freed until there is further data available in the UE buffer. Signalling whether or not the UE will continue to use the data resources to schedule its own PUSCH transmissions in this way provides an efficiency gain over known solutions, where that kind of indication may be carried in a medium access control (MAC) control element (MAC CE), since including such an indication in the control signalling is very fast and small, and can be decoded before the rest of the resources.

In an arrangement of embodiments of the present disclosure, the value of “Continuing or taking up again” may be multi-level. For example, the binary number 00 (false), 01 (the UE continues to schedule transmissions at a comparative coding rate of one quarter), 10 (the UE continues to schedule transmissions at a comparative coding rate of one half), 11 (true; the UE continues to schedule transmissions at the same coding rate). In other words, the continuation indicator indicates a relative coding rate with which the further data will be transmitted compared to the previous uplink data.

Although the resources are not actually freed except in the 00 case, the gNB can know the peak rate from the UE, and can use the remaining baseband processing capacity based on this known peak rate to deal with other scheduled UEs.

In some arrangements of embodiments of the present disclosure, if the UE frees the resources, then gNB can dynamically schedule the resources to another UE (e.g. UE2) until gNB detects further control signalling from the earlier UE (UE1). That is, both the communications device and the infrastructure equipment may be configured to determine, through the continuation indicator that the communications device is not to transmit further data within the resources of the next uplink transmission occasion, that the data resource in the next uplink transmission occasion is available for use by one or more other communications devices for transmitting uplink signals to the wireless communications network.

Accordingly, the infrastructure equipment may be configured to allocate one or more portions of the data resource to the one or more other communications devices for transmitting uplink signals to the infrastructure equipment.

When UE1 schedules control and data again for transmission, there may be some collisions between UE1 and UE2. In order to avoid at least the control information collision between the UEs—and thus allow for UE1 to always be able to send scheduling information to the gNB again and use the data resource to carry its own PUSCH transmissions—it is always assumed that the gNB will not assign the pre-configured control resource of UE1 to any other UE, but data resources can be reused for other UEs, e.g. UE2. Hence, the impact of the collision will only be on the data channels, which can be mitigated by the gNB using advanced interference cancellations provided that DMRS sequences are quasi-orthogonal between the different UEs. It should be noted that both control and data resources also contain DMRS for facilitating the channel estimations at the gNB.

In another arrangement of embodiments of the present disclosure, in case of collisions where a UE does not receive a response from gNB for a certain period of time (e.g. based on expiry of timer) including an indication of a number of required HARQ retransmissions, the UE may start a RACH procedure to inform the gNB that it has failed to receive any feedback. In this case, the UE may fall back to the legacy gNB-based scheduling mechanism. In other words, the communications device is configured to determine that no feedback has been received from the wireless communications network within a specified period in response to the communications device having transmitted the uplink data, and to initiate a random access, RACH, procedure with the wireless communications network. Here, this RACH may be started by the UE such that the UE indicates that it wants to able to continue with UE-based scheduling, or requests to fall back to gNB based scheduling, or otherwise requesting that something to be done to reduce the interference and, hence, the collisions. This RACH may have a similar (or indeed the same) format to RACH procedures initiated by idle UEs wanting to initiate a connection with the network, but here the UE may use one of a set (of one or more) reserved preambles for the specific purpose of indicating that the UE has failed to receive the feedback from the gNB. In other words, the RACH procedure may comprise transmitting, by the communications device to the wireless communications network (e.g. to the infrastructure equipment), one of a set of one or more preambles, the set of preambles indicating that no feedback has been received from the wireless communications network within the specified period in response to the communications device having transmitted the uplink data.

In another further arrangement of embodiments of the present disclosure, the UE-specific control resource can be configured to be available in every scheduling opportunity, e.g. sub-slot, slot. However, it could also be possible to be configured with some periodicities depending on traffic profile. This periodicity or pattern may be changed via signalling or configurations from the gNB, where they are likely to be configured semi-statically (for example, over 20 ms periods). In other words, the control resource may be available in all of the plurality of uplink transmission occasions. Alternatively, the control resource may be available in only a subset of the plurality of uplink transmission occasions, the subset of the plurality of uplink transmission occasions being dependent on a specified pattern. Here, the communications device may be configured to receive an indication from the wireless communications network that the specified pattern has changed.

In another further arrangement of embodiments of the present disclosure, the gNB can feed back the UL channel state information (e.g. MCS/CQI level, precoding, rank indication) to the UE periodically based on SRS transmission, unless channel reciprocity is available for the UE (e.g. TDD). Such UL channel state information may then be used by the UE to schedule its transmissions. In other words, the communications device may be configured to determine the values of the plurality of scheduling parameters through measurements performed on reference signals, where these reference signals originate from the communications device, where the measurements are performed by the wireless communications network and then fed back by the wireless communications network (e.g. by the infrastructure equipment). In case of TDD, due to channel reciprocity, the UE can apply CSI derived from DL Reference signals for the UL data scheduling. In other words, the communications device may be configured to determine the values of the plurality of scheduling parameters through measurements performed on reference signals, where these reference signals originate from the wireless communications network (i.e. they are received from the wireless communications network, e.g. from the infrastructure equipment), where the measurements are performed by the communications device.

In another further arrangement of embodiments of the present disclosure, while the PUCCH carries the scheduling information from the UE, it can also be used to contain the traditional Uplink Control Information (UCI). In other words, the scheduling information is transmitted within an uplink control channel which further comprises uplink control information. The UCI (e.g. HARQ-ACK, SR, CSI) can also be multiplexed with the scheduled data in the PUSCH channel.

In another further arrangement of embodiments of the present disclosure, UE-dynamic scheduling is only configured from the network when the measured DL reference signal received power (RSRP)/pathloss is above a certain threshold. In other words, the communications device is configured to measure a value of at least one channel characteristic of the wireless radio interface, and to determine the values of the plurality of scheduling parameters independently from the wireless communications network only if the value of the at least one channel characteristic is above a specified threshold value. Here, this channel characteristic may be RSRP, pathloss, reference signal received quality (RSRQ), SINR, CQI, or the like. This means that, when a UE is suffering from very bad channel conditions, or is located at the cell-edge, UE-dynamic scheduling is disabled and traditional gNB-based scheduling is enabled, or is at least considered as a fallback.

Alternatively, in another arrangement of embodiments of the present technique, the network may signal to the UE which enables or disables the UE-based scheduling. In other words, the communications device may be configured to receive, from the wireless communications network, downlink signalling indicating whether or not the communications device is enabled to determine the values of the plurality of scheduling parameters independently from the wireless communications network, and to determine the values of the plurality of scheduling parameters independently from the wireless communications network only if the downlink signalling indicates that the communications device is enabled to determine the values of the plurality of scheduling parameters independently from the wireless communications network.

In another further arrangement of embodiments of the present disclosure, the PUCCH can support a single coding rate or multiple coding rates. In other words, the communications device may be configured to select a coding rate from a plurality of coding rates, and to transmit the scheduling information in accordance with the selected coding rate. In the case that multiple coding rates are supported by the PUCCH, the gNB can blind decode for which coding rate a UE has used based on the channel conditions.

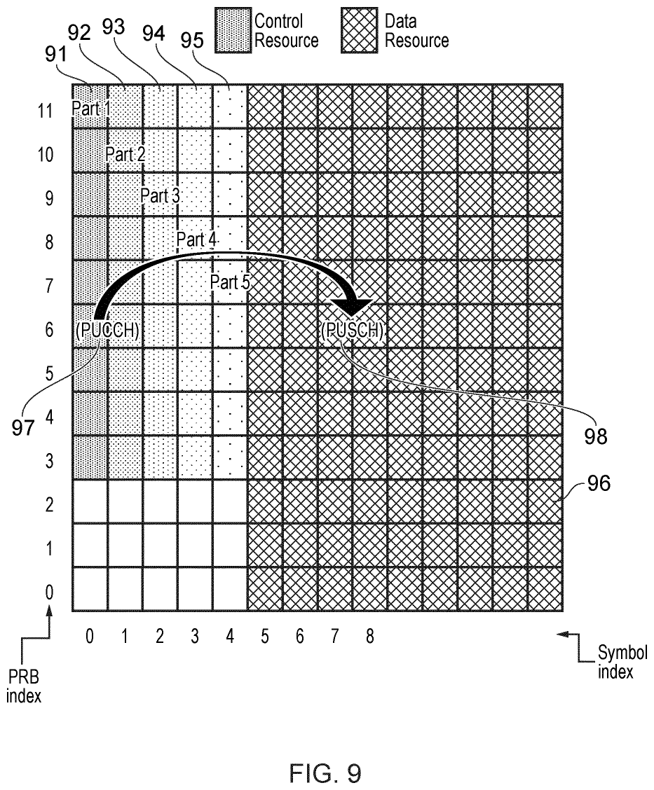

In the case that multiple coding rates are supported by the PUCCH, where such coding rates may for example be: ½, ¼, ⅛, 1/16 and 1/32, the UE-specific control resource can be broken down into a number of smaller resources 91, 92, 93, 94, 95 as shown by FIG. 9. The Part 1 control resource 91 corresponds to coding rate ½. Part 1+2 control resources 91, 92 correspond to coding rate 1/4. Part 1+2+3 control resources 91, 92, 93 correspond to coding rate 1/8. Part 1+2+3+4 control resources 91, 92, 93, 94 correspond to coding rate 1/16, and Part 1+2+3+4+5 control resources 91, 92, 93, 94, 95 correspond to coding rate 1/32. In other words, a size of the control resource is dependent on the selected coding rate.

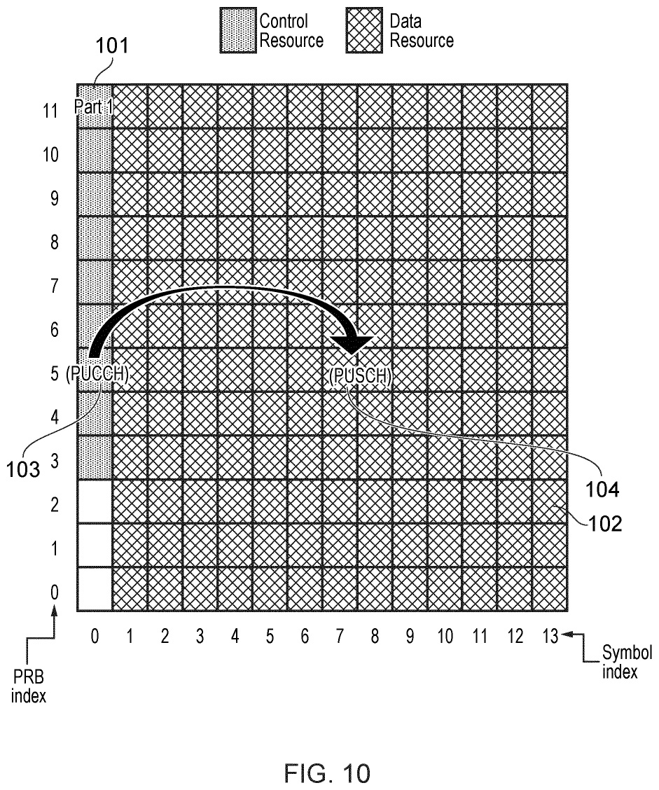

If the channel conditions are good (i.e. high SINR), a UE may use only the first part (Part 1) for placing the PUCCH. In this case, as shown by FIG. 10, the PUSCH 104 can immediately start after the Part 1 control resource 101 (corresponding to the Part 1 control resource 91 of FIG. 9) (i.e. adjacent to the control resource 101 in the time-domain) in order not to waste the remaining resources. That is, the remaining control resources 92, 93, 94, 95 compared to the example of FIG. 9 may be repurposed in the example of FIG. 10 as further data resources 102. Hence, when the gNB decodes the PUCCH 103 successfully from the Part 1 control resource 101, it can assume that the PUSCH 104 starts immediately after the Part 1 resource 101. If the channel conditions are very bad however, a UE can combine Parts 1, 2, 3, 4 and 5, and place the PUSCH 98 in the data resources 96 immediately after the Part 5 resource 95 as shown in FIG. 9. In this case, if the gNB decodes the PUCCH 97 successfully, it can assume that the PUSCH 98 starts after Part 5. Hence, the gNB and UE behaviours are aligned.

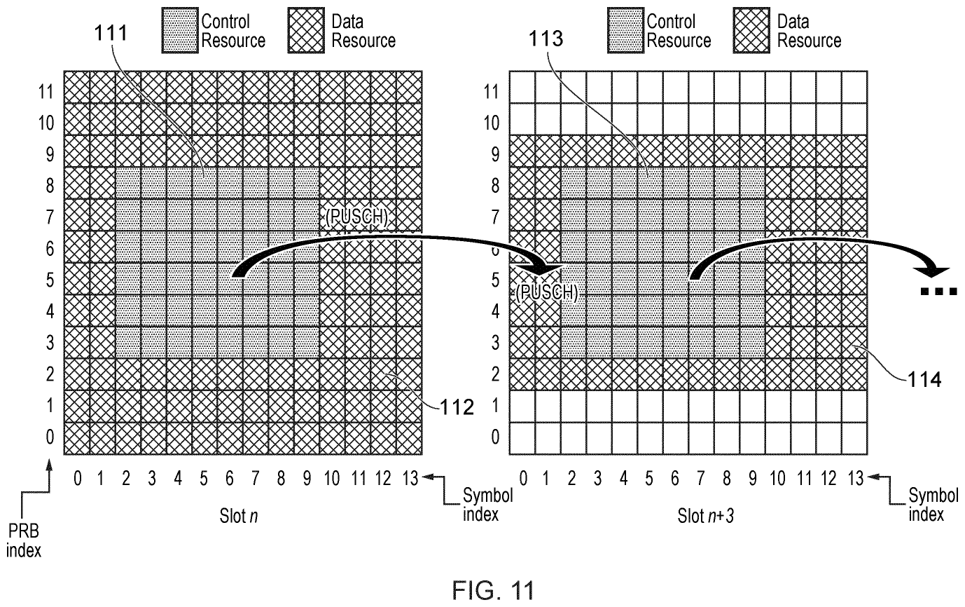

As described above, the UE can be assigned a control resource which is within the resources of the data shared channel (PUSCH). That is, the control resource is at least partially included in within the data resource within the resources. In other words, the control resource 111 is embedded within/piggy-backed onto the data resources 112 as shown in FIG. 11. Hence, a gNB decodes the uplink shared channel (PUSCH) and obtains the scheduling control information (UCI) embedded in the same PUSCH. However, as the scheduling control information is a part of the data (i.e. carried by the PUSCH within the data resources), it is not possible that the scheduling information relates to the same PUSCH. In this case, the scheduling control information relates to the next scheduling opportunity which also comprises a control resource 113 embedded within a data resource 114, for within the example next slot(s), sub slot(s) or sub fame(s) (e.g. three slots later as shown in the example of FIG. 10). In other words, the data resource in which the uplink data is transmitted is located within the next uplink transmission occasion to the uplink transmission occasion in which the control resource, in which the scheduling information is transmitted, is located.

This would mean that the first PUSCH should be scheduled dynamically by the gNB, or can be a pre-configured grant (i.e. legacy CG), and subsequent PUSCHs will be scheduled by the UE itself. The scheduling control information can be encoded separately before embedding on the data resource. The modulation scheme and power level used for the scheduling control information can be different to that allocated for actual data transmission.

In another arrangement of embodiments of the present disclosure, the control scheduling information has CRC masked with UE ID in order to identify the UE and control information. In other words, the scheduling information comprises an identifier associated with the communications device.

In one arrangement of embodiments of the present disclosure, as the scheduling for the next scheduling opportunity depends on whether the current PUSCH (and the control information) is successful at the gNB, the UE would only execute the transmission related to the next scheduling opportunity only ifit receives a positive acknowledgement from the gNB, i.e. before the slot/subframe in which the UE is scheduled in the future. In other words, the communications device is configured to determine whether the communications device has received a positive acknowledgement from the wireless communications network in response to transmitting the scheduling information, and to transmit the uplink data to the wireless communications network only if the communications device determines that it has received the positive acknowledgement.

The scheduling information from the UE may contain similar scheduling parameters as described above with respect to the separate control and data resource arrangements described with regard to the examples of FIGS. 8 to 10; e.g. resource allocation, transport block-related (TBS), HARQ-related, multiple antenna-related, and/or the “continuing or taking up again” parameter. In this case, the PUSCH does not need to occupy the whole of the pre-configured data resources, as the scheduling information provides the resource allocation for the future slot(s) or subframes.

Normally, transmission control protocol (TCP) ACK/NACK traffic or RLC-AM ACK/NACK traffic in the DL (in response to actual traffic transmitted in the UL direction) creates an opportunity for the gNB to send UL grants or UL transmission parameter adjustments. Using UDP/IP with RLC-UM mode for uplink video transmission for example however may generate few or no opportunities for DL transmission, because there will not be any RLC ACK/NACK feedback possibilities. So, a UE may be transmitting in the UL direction without receiving any feedback from the network for some time. The proposed enhancements of embodiments of the present disclosure as discussed above are applicable for these durations in addition to where there is no UL traffic as well; i.e. a camera codec viewpoint does not change. The gNB is aware of this situation, based on empty UE buffer status reports (BSRs) received from the UE. The gNB may configure a data inactivity timer such that, on expiry of this timer, the UE may be sent to IDLE mode. Normally, this timer is configured with consideration of the UE's power saving opportunities by transitioning the UE to IDLE mode and avoiding the UE bouncing between idle and connected modes due to a short configured timer value and data arrival, and so the network may therefore use a more conservative value; i.e. a longer timer for data inactivity expiry.

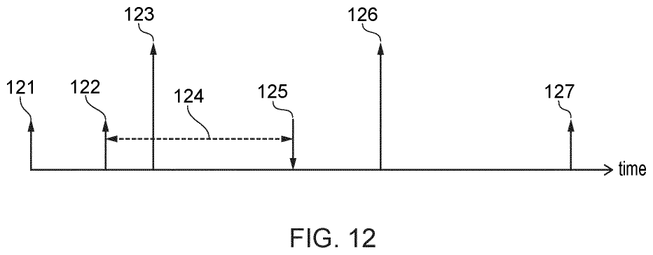

In an arrangement of embodiments of the present disclosure, as illustrated by FIG. 12, a new timer is configured by the network with a value of less than the existing data inactivity timer. This timer may be configured by the network (i.e. the network determines the value of the timer) based on the UE's capability. In other words, the infrastructure equipment may be configured to receive, from the communications device, an indication of a capability of the communications device, and to transmit, to the communications device, an indication of a value with which the communications device is to set a timer, the value being based on the indicated capability of the communications device.

The UE starts 122 this timer after sending (or the gNB otherwise detecting) 121 an empty BSR (i.e. BSR=0) or when the value of “Continuing or taking up again” is “False”, thus indicating that there is no data in the UE buffer for transmission. In other words, the communications device is configured to determine that it has no further data to transmit to the wireless communications network, to transmit, to the wireless communications network, an indication that the communications device has no further data to transmit to the wireless communications network, and to start a timer (e.g. in accordance with the value indicated by the network) based on transmitting the indication that the communications device has no further data to transmit to the wireless communications network. Here, the timer may be shorter than an existing inactivity timer maintained by the wireless communications network

If new data arrives 123 at the UE before this timer expiry, then the UE will employ techniques proposed herein by embodiments of the present disclosure for UL scheduling 124. At the timer expiry 125, the gNB will stop monitoring UL resources of UE-based scheduling, and the UE shall restart by performing a RACH procedure or falling back to using gNB-based scheduling 126. In other words, the communications device may be configured to determine, after the timer has expired, that the communications device has further data to transmit to the wireless communications network, and to transmit, to the wireless communications network, a request (e.g. in the form of a scheduling request or the initiation of a RACH or initial access procedure) for uplink communications resources of the wireless radio interface within which to transmit the further data. In a similar manner to the RACH started by the UE when it detects that no feedback has been received from the network within a specified period in response to the UE having transmitted uplink data, this RACH may have a similar (or indeed the same) format to RACH procedures initiated by idle UEs wanting to initiate a connection with the network, but here the UE may use one of a set (of one or more) reserved preambles for the specific purpose of indicating that the timer has expired, and/or that the UE either wants to begin scheduling its own uplink transmissions again, or wants to fall back to gNB-based scheduling.

Alternatively, when the new data arrives 123, the UE may stop the timer early, and not perform a RACH procedure or fall back to using gNB-based scheduling, and will continue to schedule its own transmissions in accordance with embodiments of the present disclosure until such a time that it starts the timer again. In other words, the communications device is configured to determine, after the timer has been started but before the timer expires, that the communications device has further data to transmit to the wireless communications network, and to stop the timer.

The gNB can also dynamically schedule the allocated resources to other UEs once this new timer has expired and the UE performs a RACH procedure or falls back to using gNB-based scheduling. For UE-based scheduling, the PUCCH resource periodicity may be longer for UEs capable of this feature, and should cover the cases where new traffic arrival is beyond the new timer expiry 125 and before the expiry of data inactivity timer 127. Following expiry of both timers 125, 127, the communications device may be configured to transition from the connected mode to an idle mode. This new timer is required to ensure that the gNB is not always monitoring the PUCCH resources when no data is being transmitted, as described above.

As described above, the communications device may be configured to start the timer immediately upon transmitting the indication that the communications device has no further data to transmit to the wireless communications network. Alternatively, the communications device may be configured to start the new timer following a specified period from transmitting the indication that the communications device has no further data to transmit to the wireless communications network—for example, after n slots/subframes of sending a BSR=0 as shown in FIG. 12.

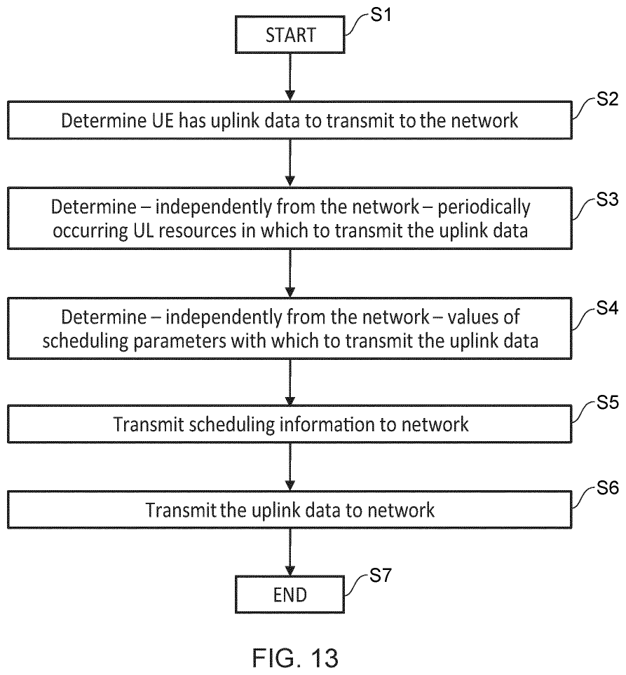

FIG. 13 shows a flow diagram illustrating an example process of communications in a communications system in accordance with embodiments of the present technique. The process shown by FIG. 13 is a method of operating a communications device configured to transmit signals to and/or to receive signals from a wireless communications network (e.g. to or from an infrastructure equipment of the wireless communications network), the communications device operating in a connected mode with the wireless communications network.

The method begins in step S1. The method comprises, in step S2, determining that the communications device has uplink data to transmit to the wireless communications network. In step S3, the process comprises determining, independently from the wireless communications network, periodically occurring uplink resources of the wireless radio interface in which the uplink data is to be transmitted, wherein the uplink resources comprise a control resource and a data resource, both of the control resource and the data resource being associated with the communications device. Then, in step S4, the process comprises determining, independently from the wireless communications network, values of a plurality of scheduling parameters with which the uplink data is to be transmitted. In step S5, the method transmitting, to the wireless communications network within the control resource, scheduling information indicating that the communications device is to transmit the uplink data to the wireless communications network in accordance with the determined values of the plurality of scheduling parameters. Then, in step S6, the process comprises transmitting, to the wireless communications network within the data resource, the uplink data in accordance with the determined values of the plurality of scheduling parameters. The process ends in step S7.

Those skilled in the art would appreciate that the method shown by FIG. 13 may be adapted in accordance with embodiments of the present technique. For example, other intermediate steps may be included in this method, or the steps may be performed in any logical order. Though embodiments of the present technique have been described largely by way of the example communications system shown in FIG. 7, and the examples described with respect to FIGS. 8 to 12, it would be clear to those skilled in the art that they could be equally applied to other systems to those described herein.

Those skilled in the art would further appreciate that such infrastructure equipment and/or communications devices as herein defined may be further defined in accordance with the various arrangements and embodiments discussed in the preceding paragraphs. It would be further appreciated by those skilled in the art that such infrastructure equipment and communications devices as herein defined and described may form part of communications systems other than those defined by the present disclosure.

The following numbered paragraphs provide further example aspects and features of the present technique:

Paragraph 1. A method of operating a communications device configured to transmit signals to and/or to receive signals from a wireless communications network via a wireless radio interface provided by the wireless communications network, the method comprising
determining that the communications device has uplink data to transmit to the wireless communications network,
determining, independently from the wireless communications network, periodically occurring uplink resources of the wireless radio interface in which the uplink data is to be transmitted, wherein the uplink resources comprise a control resource and a data resource, both of the control resource and the data resource being associated with the communications device,
determining, independently from the wireless communications network, values of a plurality of scheduling parameters with which the uplink data is to be transmitted,
transmitting, to the wireless communications network within the control resource, scheduling information indicating that the communications device is to transmit the uplink data to the wireless communications network in accordance with the determined values of the plurality of scheduling parameters, and
transmitting, to the wireless communications network within the data resource, the uplink data in accordance with the determined values of the plurality of scheduling parameters.
   Paragraph 2. A method according to Paragraph 1, wherein the location of the control resource in the resources is preconfigured and known to both the communications device and the wireless communications network.
   Paragraph 3. A method according to Paragraph 1 or Paragraph 2, wherein the control resource is separate from the data resource within the resources.
   Paragraph 4. A method according to Paragraph 3, wherein the data resource in which the uplink data is transmitted is within the same uplink transmission occasion as the control resource in which the scheduling information is transmitted.
   Paragraph 5. A method according to Paragraph 1, wherein the control resource is at least partially included in the data resource within the resources.
   Paragraph 6. A method according to Paragraph 5, wherein the data resource in which the uplink data is to be transmitted is located within the next uplink transmission occasion to the uplink transmission occasion in which the control resource, in which the scheduling information is transmitted, is located.
   Paragraph 7. A method according to Paragraph 6, comprising
determining whether the communications device has received a positive acknowledgement from the wireless communications network in response to transmitting the scheduling information, and
transmitting the uplink data to the wireless communications network only if the communications device determines that it has received the positive acknowledgement.
   Paragraph 8. A method according to any of Paragraphs 1 to 7, wherein the plurality of scheduling parameters comprises a continuation indicator, the continuation indicator being included within the scheduling information and indicating whether or not the communications device is to transmit further data within resources of the next uplink transmission occasion to the uplink transmission occasion in which the uplink data is transmitted.
   Paragraph 9. A method according to Paragraph 8, wherein the continuation indicator indicates a relative coding rate with which the further data will be transmitted compared to the uplink data.
   Paragraph 10. A method according to Paragraph 8 or Paragraph 9, comprising
determining, if the continuation indicator that the communications device is not to transmit further data within the resources of the next uplink transmission occasion, that the data resource in the next uplink transmission occasion is available for use by one or more other communications devices for transmitting uplink signals to the wireless communications network.
   Paragraph 11. A method according to any of Paragraphs 1 to 10, comprising
determining that no feedback has been received from the wireless communications network within a specified period in response to the communications device having transmitted the uplink data, and
initiating a random access, RACH, procedure with the wireless communications network.
   Paragraph 12. A method according to Paragraph 11, wherein the RACH procedure comprises transmitting, by the communications device to the wireless communications network, one of a set of one or more preambles, the set of preambles indicating that no feedback has been received from the wireless communications network within the specified period in response to the communications device having transmitted the uplink data.
   Paragraph 13. A method according to any of Paragraphs 1 to 12, wherein the control resource is available in all of the plurality of uplink transmission occasions.
   Paragraph 14. A method according to any of Paragraphs 1 to 12, wherein the control resource is available in only a subset of the plurality of uplink transmission occasions, the subset of the plurality of uplink transmission occasions being dependent on a specified pattern.
   Paragraph 15. A method according to Paragraph 14, comprising
receiving an indication from the wireless communications network that the specified pattern has changed.
   Paragraph 16. A method according to any of Paragraphs 1 to 15, comprising
determining the values of the plurality of scheduling parameters through measurements performed on reference signals.
   Paragraph 17. A method according to Paragraph 16, wherein the reference signals originate from the wireless communications network, and the measurements are performed by the communications device.
   Paragraph 18. A method according to Paragraph 16, wherein the reference signals originate from the communications device, and the measurements are performed by and fed back from the wireless communications network.
   Paragraph 19. A method according to any of Paragraphs 1 to 18, wherein the scheduling information is transmitted within an uplink control channel which further comprises other uplink control information.
   Paragraph 20. A method according to any of Paragraphs 1 to 19, comprising measuring a value of at least one channel characteristic of the wireless radio interface, and determining the values of the plurality of scheduling parameters independently from the wireless communications network only if the value of the at least one channel characteristic is above a specified threshold value.
   Paragraph 21. A method according to Paragraph 20, wherein the at least one channel characteristic comprises a reference signal received power, RSRP.
   Paragraph 22. A method according to any of Paragraphs 1 to 21, comprising receiving, from the wireless communications network, downlink signalling indicating whether or not the communications device is enabled to determine the values of the plurality of scheduling parameters independently from the wireless communications network, and determining the values of the plurality of scheduling parameters independently from the wireless communications network only if the downlink signalling indicates that the communications device is enabled to determine the values of the plurality of scheduling parameters independently from the wireless communications network.
   Paragraph 23. A method according to any of Paragraphs 1 to 22, comprising selecting a coding rate from a plurality of coding rates, and transmitting the scheduling information in accordance with the selected coding rate.
   Paragraph 24. A method according to Paragraph 23, wherein a size of the control resource is dependent on the selected coding rate.
   Paragraph 25. A method according to any of Paragraphs 1 to 24, wherein the scheduling information comprises an identifier associated with the communications device.
   Paragraph 26. A method according to any of Paragraphs 1 to 25, comprising determining that the communications device has no further data to transmit to the wireless communications network, transmitting, to the wireless communications network, an indication that the communications device has no further data to transmit to the wireless communications network, and starting a timer based on transmitting the indication that the communications device has no further data to transmit to the wireless communications network.
   Paragraph 27. A method according to Paragraph 26, comprising determining, after the timer has been started but before the timer expires, that the communications device has further data to transmit to the wireless communications network, and stopping the timer.
   Paragraph 28. A method according to Paragraph 26 or Paragraph 27, comprising determining that the timer has expired, determining, after the timer has expired, that the communications device has further data to transmit to the wireless communications network, and transmitting, to the wireless communications network, a request for uplink communications resources of the wireless radio interface within which to transmit the further data.
   Paragraph 29. A method according to any of Paragraphs 26 to 28, wherein the timer is shorter than an existing inactivity timer maintained by the wireless communications network.
   Paragraph 30. A method according to any of Paragraphs 26 to 29, comprising starting the timer immediately upon transmitting the indication that the communications device has no further data to transmit to the wireless communications network.
   Paragraph 31. A method according to any of Paragraphs 26 to 30, comprising starting the timer following a specified period from transmitting the indication that the communications device has no further data to transmit to the wireless communications network.
   Paragraph 32. A method according to any of Paragraphs 1 to 31, wherein the scheduling information is transmitted as uplink control information, UCI.
   Paragraph 33. A method according to any of Paragraphs 1 to 32, wherein the plurality of scheduling parameters each relate to at least one of:
information relating to a resource allocation for the uplink data;
information relating to transport blocks to be used to carry the uplink data;
information regarding a Hybrid Automatic Repeat Request, HARQ, protocol in accordance with which the uplink data is to be transmitted; and information regarding one or more antennas of the communications device via which the uplink data is to be transmitted.
   Paragraph 34. A method according to any of Paragraphs 1 to 33, wherein the scheduling information is transmitted within a Physical Uplink Control Channel, PUCCH.
   Paragraph 35. A method according to any of Paragraphs 1 to 34, wherein the uplink data is transmitted within a Physical Uplink Shared Channel, PUSCH.
   Paragraph 36. A method according to any of Paragraphs 1 to 35, wherein the communications device operates in a connected mode with the wireless communications network.
   Paragraph 37. A communications device comprising
transceiver circuitry configured to transmit signals to and/or to receive signals from a wireless communications network via a wireless radio interface provided by the wireless communications network, and
controller circuitry configured in combination with the transceiver circuitry
to determine that the communications device has uplink data to transmit to the wireless communications network,
to determine, independently from the wireless communications network, periodically occurring uplink resources of the wireless radio interface in which the uplink data is to be transmitted, wherein the uplink resources comprise a control resource and a data resource, both of the control resource and the data resource being associated with the communications device,
to determine, independently from the wireless communications network, values of a plurality of scheduling parameters with which the uplink data is to be transmitted,
to transmit, to the wireless communications network within the control resource, scheduling information indicating that the communications device is to transmit the uplink data to the wireless communications network in accordance with the determined values of the plurality of scheduling parameters, and
to transmit, to the wireless communications network within the data resource, the uplink data in accordance with the determined values of the plurality of scheduling parameters.
   Paragraph 38. Circuitry for a communications device, the circuitry comprising
transceiver circuitry configured to transmit signals to and/or to receive signals from a wireless communications network via a wireless radio interface provided by the wireless communications network, and
controller circuitry configured in combination with the transceiver circuitry
to determine that the communications device has uplink data to transmit to the wireless communications network,
to determine, independently from the wireless communications network, periodically occurring uplink resources of the wireless radio interface in which the uplink data is to be transmitted, wherein the uplink resources comprise a control resource and a data resource, both of the control resource and the data resource being associated with the communications device,
to determine, independently from the wireless communications network, values of a plurality of scheduling parameters with which the uplink data is to be transmitted,
to transmit, to the wireless communications network within the control resource, scheduling information indicating that the transceiver circuitry is to transmit the uplink data to the wireless communications network in accordance with the determined values of the plurality of scheduling parameters, and
to transmit, to the wireless communications network within the data resource, the uplink data in accordance with the determined values of the plurality of scheduling parameters.
   Paragraph 39. A method of operating an infrastructure equipment forming part of a wireless communications network, the infrastructure equipment being configured to transmit signals to and/or to receive signals from a communications device via a wireless radio interface provided by the infrastructure equipment, the method comprising
receiving, from the communications device, scheduling information indicating that the communications device is to transmit uplink data to the infrastructure equipment in accordance with values of a plurality of scheduling parameters which have been determined by the communications device independently from the infrastructure equipment, wherein the scheduling information indicates that the uplink data is to be transmitted in periodically occurring uplink resources, wherein the uplink resources comprise a control resource and a data resource, both of the control resource and the data resource being associated with the communications device, and wherein the scheduling information is received within the control resource, and
receiving, from the communications device within the data resource, the uplink data in accordance with the indicated values of the plurality of scheduling parameters.
   Paragraph 40. A method according to Paragraph 39, wherein the location of the control resource in the resources is preconfigured and known to both the communications device and the infrastructure equipment.
   Paragraph 41. A method according to Paragraph 39 or Paragraph 40, wherein the control resource is separate from the data resource within the resources.
   Paragraph 42. A method according to Paragraph 41, wherein the data resource in which the uplink data is received is within the same uplink transmission occasion as the control resource in which the scheduling information is received.
   Paragraph 43. A method according to Paragraph 39, wherein the control resource is at least partially included in the data resource within the resources.
   Paragraph 44. A method according to Paragraph 43, wherein the data resource in which the uplink data is received is located within the next uplink transmission occasion to the uplink transmission occasion in which the control resource, in which the scheduling information is received, is located.
   Paragraph 45. A method according to Paragraph 44, comprising
transmitting a positive acknowledgement to the communications device in response to receiving the scheduling information.
   Paragraph 46. A method according to any of Paragraphs 39 to 45, wherein the plurality of scheduling parameters comprises a continuation indicator, the continuation indicator being included within the scheduling information and indicating whether or not the communications device is to transmit further data within resources of the next uplink transmission occasion to the uplink transmission occasion in which the uplink data is received.
   Paragraph 47. A method according to Paragraph 46, wherein the continuation indicator indicates a relative coding rate with which the further data will be received compared to the uplink data.
   Paragraph 48. A method according to Paragraph 46 or Paragraph 47, comprising determining, if the continuation indicator that the communications device is not to transmit further data within the resources of the next uplink transmission occasion, that the data resource in the next uplink transmission occasion is available for use by one or more other communications devices for transmitting uplink signals to the infrastructure equipment.
   Paragraph 49. A method according to Paragraph 48, comprising
allocating one or more portions of the data resource to the one or more other communications devices for transmitting uplink signals to the infrastructure equipment.
   Paragraph 50. A method according to any of Paragraphs 39 to 49, wherein the control resource is available in all of the plurality of uplink transmission occasions.
   Paragraph 51. A method according to any of Paragraphs 39 to 49, wherein the control resource is available in only a subset of the plurality of uplink transmission occasions, the subset of the plurality of uplink transmission occasions being dependent on a specified pattern.
   Paragraph 52. A method according to Paragraph 51, comprising
determining that the specified pattern is to be changed, and
transmitting an indication to the communications device that the specified pattern has changed.
   Paragraph 53. A method according to any of Paragraphs 39 to 52, comprising
transmitting reference signals to the communications device, the reference signals being for use by the communications device for performing measurements to determine the values of the plurality of scheduling parameters.
   Paragraph 54. A method according to any of Paragraphs 39 to 53, comprising
receiving reference signals from the communications device,
performing measurements on the received reference signals, and
transmitting feedback indicating the performed measurements to the communications device, the measurements being for use by the communications device in determining the values of the plurality of scheduling parameters.
   Paragraph 55. A method according to any of Paragraphs 39 to 54, wherein the scheduling information is received within an uplink control channel which further comprises uplink control information.
   Paragraph 56. A method according to any of Paragraphs 39 to 55, comprising
transmitting, to the communications device, downlink signalling indicating whether or not the communications device is enabled to determine the values of the plurality of scheduling parameters independently from the wireless communications network, and
determining that the communications device will determine the values of the plurality of scheduling parameters independently from the wireless communications network only if the downlink signalling indicates that the communications device is enabled to determine the values of the plurality of scheduling parameters independently from the wireless communications network.
   Paragraph 57. A method according to any of Paragraphs 39 to 56, comprising
receive the scheduling information in accordance with a coding rate selected by the communications device from among a plurality of coding rates,
wherein a size of the control resource is dependent on the selected coding rate.
   Paragraph 58. A method according to any of Paragraphs 39 to 57, wherein the scheduling information comprises an identifier associated with the communications device.
   Paragraph 59. A method according to any of Paragraphs 39 to 58, comprising
receiving, from the communications device, an indication of a capability of the communications device, and
transmitting, to the communications device, an indication of a value with which the communications device is to set a timer, the value being based on the indicated capability of the communications device.
   Paragraph 60. A method according to Paragraph 59, comprising
receiving, from the communications device, an indication that the communications device has no further data to transmit to the infrastructure equipment, and
determining that the communications device will start the timer in accordance with the indicated value based on having transmitted the indication that the communications device has no further data to transmit to the infrastructure equipment.
   Paragraph 61. A method according to Paragraph 59 or Paragraph 60, wherein the timer is shorter than an existing inactivity timer maintained by the infrastructure equipment.
   Paragraph 62. A method according to any of Paragraphs 59 to 61, comprising
determining that the communications device will start the timer immediately upon transmitting the indication that the communications device has no further data to transmit to the infrastructure equipment.
   Paragraph 63. A method according to any of Paragraphs 59 to 62, comprising determining that the communications device will start the timer following a specified period from transmitting the indication that the communications device has no further data to transmit to the infrastructure equipment.
   Paragraph 64. A method according to any of Paragraphs 39 to 63, wherein the scheduling information is received as uplink control information, UCI.
   Paragraph 65. A method according to any of Paragraphs 39 to 64, wherein the plurality of scheduling parameters each relate to at least one of:
information relating to a resource allocation for the uplink data;
information relating to transport blocks to be used to carry the uplink data;
information regarding a Hybrid Automatic Repeat Request, HARQ, protocol in accordance with which the uplink data is to be transmitted; and
information regarding one or more antennas of the communications device via which the uplink data is to be transmitted.
   Paragraph 66. A method according to any of Paragraphs 39 to 65, wherein the scheduling information is received within a Physical Uplink Control Channel, PUCCH.
   Paragraph 67. A method according to any of Paragraphs 39 to 66, wherein the uplink data is received within a Physical Uplink Shared Channel, PUSCH.
   Paragraph 68. A method according to any of Paragraphs 39 to 67, wherein the communications device operates in a connected mode with the wireless communications network.
   Paragraph 69. An infrastructure equipment forming part of a wireless communications network, the infrastructure equipment comprising
transceiver circuitry configured to transmit signals to and/or to receive signals from a communications device via a wireless radio interface provided by the infrastructure equipment, and
controller circuitry configured in combination with the transceiver circuitry
to receive, from the communications device, scheduling information indicating that the communications device is to transmit uplink data to the infrastructure equipment in accordance with values of a plurality of scheduling parameters which have been determined by the communications device independently from the infrastructure equipment, wherein the scheduling information indicates that the uplink data is to be transmitted in periodically occurring uplink resources, wherein the uplink resources comprise a control resource and a data resource, both of the control resource and the data resource being associated with the communications device, and wherein the scheduling information is received within the control resource, and
to receive, from the communications device within the data resource, the uplink data in accordance with the indicated values of the plurality of scheduling parameters.
   Paragraph 70. Circuitry for an infrastructure equipment forming part of a wireless communications network, the infrastructure equipment comprising
transceiver circuitry configured to transmit signals to and/or to receive signals from a communications device via a wireless radio interface provided by the infrastructure equipment, and
controller circuitry configured in combination with the transceiver circuitry
to receive, from the communications device, scheduling information indicating that the communications device is to transmit uplink data to the infrastructure equipment in accordance with values of a plurality of scheduling parameters which have been determined by the communications device independently from the infrastructure equipment, wherein the scheduling information indicates that the uplink data is to be transmitted in of periodically occurring uplink resources, wherein the uplink resources comprise a control resource and a data resource, both of the control resource and the data resource being associated with the communications device, and wherein the scheduling information is received within the control resource, and
to receive, from the communications device within the data resource, the uplink data in accordance with the indicated values of the plurality of scheduling parameters.
   Paragraph 71. A wireless communications system comprising a communications device according to Paragraph 37 and an infrastructure equipment according to Paragraph 69.
   Paragraph 72. A computer program comprising instructions which, when loaded onto a computer, cause the computer to perform a method according to any of Paragraphs 1 to 36 or Paragraphs 39 to 68.
   Paragraph 73. A non-transitory computer-readable storage medium storing a computer program according to Paragraph 72.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] Holma H. and Toskala A, “LTE for UMTS OFDMA and SC-FDMA based radio access”, John Wiley and Sons, 2009.
[2] TR 38.913, “Study on Scenarios and Requirements for Next Generation Access Technologies (Release 14)”, third Generation Partnership Project, v14.3.0.
[3] RP-190726, “Physical layer enhancements for NR ultra-reliable and low latency communication (URLLC)”, Huawei, HiSilicon, RAN #83.
[4] RP-201310, “Revised WID: Enhanced Industrial Internet of Things (IoT) and ultra-reliable and low latency communication (URLLC) support for NR,” Nokia, Nokia Shanghai Bell, RAN #88e.
[5] European patent application with publication number EP3837895.

1. A method of operating a communications device configured to transmit signals to and/or to receive signals from a wireless communications network via a wireless radio interface provided by the wireless communications network, the method comprising
determining that the communications device has uplink data to transmit to the wireless communications network,
determining, independently from the wireless communications network, periodically occurring uplink resources of the wireless radio interface in which the uplink data is to be transmitted, wherein the uplink resources comprise a control resource and a data resource, both of the control resource and the data resource being associated with the communications device,
determining, independently from the wireless communications network, values of a plurality of scheduling parameters with which the uplink data is to be transmitted,
transmitting, to the wireless communications network within the control resource, scheduling information indicating that the communications device is to transmit the uplink data to the wireless communications network in accordance with the determined values of the plurality of scheduling parameters, and
transmitting, to the wireless communications network within the data resource, the uplink data in accordance with the determined values of the plurality of scheduling parameters.

2. A method according to claim 1, wherein the location of the control resource in the resources is preconfigured and known to both the communications device and the wireless communications network.

3. A method according to claim 1, wherein the control resource is separate from the data resource within the resources.

4. A method according to claim 3, wherein the data resource in which the uplink data is transmitted is within the same uplink transmission occasion as the control resource in which the scheduling information is transmitted.

5. A method according to claim 1, wherein the control resource is at least partially included in the data resource within the resources.

6. A method according to claim 5, wherein the data resource in which the uplink data is to be transmitted is located within the next uplink transmission occasion to the uplink transmission occasion in which the control resource, in which the scheduling information is transmitted, is located.

7. A method according to claim 6, comprising
determining whether the communications device has received a positive acknowledgement from the wireless communications network in response to transmitting the scheduling information, and
transmitting the uplink data to the wireless communications network only if the communications device determines that it has received the positive acknowledgement.

8. A method according to claim 1, wherein the plurality of scheduling parameters comprises a continuation indicator, the continuation indicator being included within the scheduling information and indicating whether or not the communications device is to transmit further data within resources of the next uplink transmission occasion to the uplink transmission occasion in which the uplink data is transmitted.

9. A method according to claim 8, wherein the continuation indicator indicates a relative coding rate with which the further data will be transmitted compared to the uplink data.

10. A method according to claim 8, comprising
determining, if the continuation indicator that the communications device is not to transmit further data within the resources of the next uplink transmission occasion, that the data resource in the next uplink transmission occasion is available for use by one or more other communications devices for transmitting uplink signals to the wireless communications network.

11. A method according to claim 1, comprising
determining that no feedback has been received from the wireless communications network within a specified period in response to the communications device having transmitted the uplink data, and
initiating a random access, RACH, procedure with the wireless communications network.

12. (canceled)

13. A method according to claim 1, wherein the control resource is available in all of the plurality of uplink transmission occasions.

14. A method according to claim 1, wherein the control resource is available in only a subset of the plurality of uplink transmission occasions, the subset of the plurality of uplink transmission occasions being dependent on a specified pattern.

15. (canceled)

16. A method according to claim 1, comprising
determining the values of the plurality of scheduling parameters through measurements performed on reference signals.

17.-18. (canceled)

19. A method according to claim 1, wherein the scheduling information is transmitted within an uplink control channel which further comprises other uplink control information.

20. A method according to claim 1, comprising
measuring a value of at least one channel characteristic of the wireless radio interface, and
determining the values of the plurality of scheduling parameters independently from the wireless communications network only if the value of the at least one channel characteristic is above a specified threshold value.

21. A method according to claim 20, wherein the at least one channel characteristic comprises a reference signal received power, RSRP.

22. A method according to claim 1, comprising
receiving, from the wireless communications network, downlink signalling indicating whether or not the communications device is enabled to determine the values of the plurality of scheduling parameters independently from the wireless communications network, and
determining the values of the plurality of scheduling parameters independently from the wireless communications network only if the downlink signalling indicates that the communications device is enabled to determine the values of the plurality of scheduling parameters independently from the wireless communications network.

23.-36. (canceled)

37. A communications device comprising
transceiver circuitry configured to transmit signals to and/or to receive signals from a wireless communications network via a wireless radio interface provided by the wireless communications network, and
controller circuitry configured in combination with the transceiver circuitry
to determine that the communications device has uplink data to transmit to the wireless communications network,
to determine, independently from the wireless communications network, periodically occurring uplink resources of the wireless radio interface in which the uplink data is to be transmitted, wherein the uplink resources comprise a control resource and a data resource, both of the control resource and the data resource being associated with the communications device,
to determine, independently from the wireless communications network, values of a plurality of scheduling parameters with which the uplink data is to be transmitted,
to transmit, to the wireless communications network within the control resource, scheduling information indicating that the communications device is to transmit the uplink data to the wireless communications network in accordance with the determined values of the plurality of scheduling parameters, and
to transmit, to the wireless communications network within the data resource, the uplink data in accordance with the determined values of the plurality of scheduling parameters.

38.-68. (canceled)

69. An infrastructure equipment forming part of a wireless communications network, the infrastructure equipment comprising
transceiver circuitry configured to transmit signals to and/or to receive signals from a communications device via a wireless radio interface provided by the infrastructure equipment, and
controller circuitry configured in combination with the transceiver circuitry
to receive, from the communications device, scheduling information indicating that the communications device is to transmit uplink data to the infrastructure equipment in accordance with values of a plurality of scheduling parameters which have been determined by the communications device independently from the infrastructure equipment, wherein the scheduling information indicates that the uplink data is to be transmitted in periodically occurring uplink resources, wherein the uplink resources comprise a control resource and a data resource, both of the control resource and the data resource being associated with the communications device, and wherein the scheduling information is received within the control resource, and
to receive, from the communications device within the data resource, the uplink data in accordance with the indicated values of the plurality of scheduling parameters.

70.-73. (canceled)
